(19) United States
(12) Patent Application Publication
(10) Pub. No.: US 2014/0267840 A1
(43) Pub. Date: Sep. 18, 2014

(54) CAMERA AND IMAGE PROCESSING METHOD

(71) Applicant: Seiko Epson Corporation, Tokyo (JP)

(72) Inventor: Tatsuaki FUNAMOTO, Shiojiri (JP)

(73) Assignee: Seiko Epson Corporation, Tokyo (JP)

(21) Appl. No.: 14/206,198

(22) Filed: Mar. 12, 2014

(30) Foreign Application Priority Data
Mar. 13, 2013 (JP) 2013-050096

(51) Int. Cl. H04N 5/243

(52) U.S. Cl. CPC H04N 5/243
USPC 348/246

(57) ABSTRACT

A spectroscopic analysis apparatus includes a light source section that radiates light toward an object being imaged, an imaging section that captures light reflected off the object being imaged to acquire an image, a pixel detector that detects an abnormal pixel in the image which is a pixel where a reflectance ratio is greater than or equal to 1 and detects normal pixels in the image each of which is a pixel where the reflectance ratio is smaller than 1, and a light amount corrector that calculates a light amount correction value based on the amounts of light at normal pixels in a pixel area including the abnormal pixel in the image and replaces the amount of light at the abnormal pixel with the light amount correction value.

### BACKGROUND

1. Technical Field

The present invention relates to a camera and an image processing method.

2. Related Art

There is a known apparatus of related art that radiates light toward an object being imaged and captures light reflected off the object being imaged to produce a captured image (see JP-A-2009-33222, for example).

The imaging apparatus (spectroscopic camera) described in JP-A-2009-33222 causes light from the object to be incident on a Fabry-Perot interference filter and allows an image sensor to receive light having passed through the Fabry-Perot interference filter for acquisition of a spectroscopic image.

A spectroscopic camera using a Fabry-Perot interference filter has an advantage of being compact and lightweight, as described in JP-A-2009-33222. On the other hand, to acquire a spectroscopic image based on a sufficient amount of near infrared light, a near infrared light source needs to be provided in an imaging apparatus body. However, providing such a light source in the spectroscopic camera, which is compact as described above, results in a short distance between the light source and an imaging lens. In this case, light specularly reflected off the surface of an object being imaged enters the imaging lens, undesirably resulting in abnormal brightness of part of a spectroscopic image.

### SUMMARY

An advantage of some aspects of the invention is to provide a camera capable of acquiring a high-precision image even when light from a light source is specularly reflected off the surface of an object being imaged and also provide an image processing method.

An aspect of the invention is directed to a camera including a light source section that radiates light toward an object being imaged, an imaging section that captures light reflected off the object being imaged to acquire an image, a pixel detection section that detects an abnormal pixel in the image which is a pixel where the ratio of the amount of light at the pixel to a reference amount of light obtained when a reference object is irradiated with the light is greater than or equal to a predetermined value and detects normal pixels in the image each of which is a pixel where the ratio is smaller than the predetermined value, and a light amount correction section that calculates a light amount correction value based on the amounts of light at normal pixels out of the normal pixels that are separated from the abnormal pixel in the image but located within a predetermined distance range and replaces the amount of light at the abnormal pixel with the light amount correction value.

The reference object in the aspect of the invention is, for example, a reference white plate or any object having a perfect diffusing surface or a quasi-perfect diffusing surface. Consider a case where a perfect diffusing surface is irradiated with light and the amount of light reflected off the perfect diffusing surface is used as a reference amount of light. The ratio of the amount of light at each pixel in a captured image to the reference amount of light is a reflectance ratio with respect to the perfect diffusing surface. When specular reflection occurs at a portion of the surface of the object being imaged, the portion has reflectance greater than that of the perfect diffusing surface, and the reflectance ratio is therefore greater than “1”. The pixel detection section can therefore detect an abnormal pixel corresponding to the specular reflection portion and a normal pixel corresponding to a diffuse reflection portion.

The reference amount of light is not limited to the amount of light reflected off a perfect diffusing surface. For example, the surface of the reference object may absorb or otherwise interact with part of light incident thereon. In this case, the reflectance has a finite value lower than 100% (99%, for example). When the amount of light reflected off such a reference object is used as the reference amount of light, the pixel detection section can detect a pixel where the reflectance ratio is greater than a predetermined value smaller than 1 (0.99, for example) as an abnormal pixel corresponding to specular reflection.

In the aspect of the invention, the pixel detection section detects an abnormal pixel and normal pixels in an image, and the light amount correction section calculates a light amount correction value based on the amounts of normal pixels around the abnormal pixel and replaces the amount of light at the abnormal pixel with the light amount correction value. The amount of light at the abnormal pixel can thus be replaced with an appropriate light amount value, whereby an image having no pixel showing an abnormal amount of light corresponding to a specular reflection portion can be acquired.

In the camera according to the aspect of the invention, it is preferable that the camera further includes a spectroscopic device that selects and separates light of a predetermined wavelength from the light reflected off the object being imaged, and the imaging section captures the light of the wavelength selected by the spectroscopic device to acquire the image.

In the aspect of the invention with the configuration described above, as the image to be acquired, a spectroscopic image produced by capturing light of a predetermined wavelength separated by the spectroscopic device is acquired. In this configuration, the amount of light at an abnormal pixel corresponding to a specular reflection portion in the spectroscopic image can be corrected to the light amount correction value calculated based on the amount of light at a normal pixel, whereby a high-precision spectroscopic image can be acquired.

In the camera according to the aspect of the invention, it is preferable that the light amount correction section calculates the light amount correction value in the form of the average of the amounts of light at the normal pixels located within the predetermined distance range.

In the aspect of the invention with the configuration described above, since the light amount correction value is the average of the amounts of light at normal pixels, the light amount correction value can be readily calculated.

In the camera according to the aspect of the invention, it is preferable that the light amount correction section calculates the light amount correction value in the form of the median of the amounts of light at the normal pixels located within the predetermined distance range.

In the aspect of the invention with the configuration described above, the median of the amounts of light at normal pixels is calculated as the light amount correction value. When the amounts of light at the pixels in the image vary from each other, for example, when an edge portion is present in a pixel area, using the average as the light amount correction value possibly results in a large error. In contrast, when the median is used as the light amount correction value, the amount of light that belongs to a large population can be used in the case where the amounts of light vary from each other in the pixel area, whereby correction using a normal amount of light is more likely to be made.

In the camera according to the aspect of the invention, it is preferable that the light amount correction section calculates the light amount correction value in the form of the average of the amounts of light in the quartile range at the normal pixels located within the predetermined distance range.

In the aspect of the invention with the configuration described above, the average of the amounts of light at normal pixels in the quartile range is calculated as the light amount correction value. In this case, any pixel located within the pixel area but showing an amount of light that greatly deviates from those at other normal pixels can be excluded, whereby the amount of light at an abnormal pixel can be likely to be corrected by using a more appropriate amount of light.

In the camera according to the aspect of the invention, it is preferable that the camera further includes an input section that sets the predetermined value based on which each pixel in the image is determined to be an abnormal pixel or a normal pixel.

In the aspect of the invention with the configuration described above, the camera further includes an input section that sets the predetermined value, and a user can, for example, operate the input section to set the predetermined value. Further, the input section may be configured, for example, to automatically change (reduce, for example) the predetermined value when the number of abnormal pixels in an acquired image is greater than or equal to a predetermined upper limit.

In this configuration, for example, when too many abnormal pixels in a captured image lower the precision in the light amount correction based on normal pixels, abnormal pixel detection sensitivity can be lowered for more appropriate light amount correction.

In the camera according to the aspect of the invention, it is preferable that the camera further includes an input section that sets the predetermined distance range that defines a range within which the normal pixels used to correct the amount of light at the abnormal pixel are located.

In the aspect of the invention with the configuration described above, the camera further includes an input section that set the predetermined distance, and the user can, for example, operate the input section to set the predetermined distance. Further, the input section may be configured to automatically change the predetermined distance in accordance with the number of abnormal pixels located around the abnormal pixel in an acquired image, the position of an edge portion where the amount of light greatly changes, or other factors.

In this configuration, for example, when a predetermined distance set based on user's operation is used, the user can check an image and then set an area (predetermined distance described above) in which a small number of abnormal pixels are present. Further, when such an area is automatically set in accordance with the number of normal pixels around an abnormal pixel, and the number of abnormal pixels is large, increasing the predetermined distance allows an area for calculating the light amount correction value to be so set that a large number of normal pixels are present in the area, whereby the amount of light at the abnormal pixel can precisely be corrected to a normal amount of light. Further, in this case, when the number of abnormal pixels is small, reducing the predetermined distance allows the light amount correction value to be calculated based on normal pixels closer to the detected abnormal pixel, whereby a precise light amount correction value can be calculated.

Further, for example, the predetermined distance may be so set after edge detection or any other image processing that no edge portion is contained. In this case, the amounts of light at normal pixels for the light amount correction value calculation include no amount of light in an edge portion where the amount of light greatly changes, whereby a precise light amount correction value can be calculated.

In the camera according to the aspect of the invention, it is preferable that the spectroscopic device is capable of changing the wavelength to be selected.

In the aspect of the invention with the configuration described above, since the wavelength of light to be separated by the spectroscopic device can be changed, spectroscopic images corresponding to a plurality of wavelengths can be acquired. Replacing the amount of light at an abnormal pixel corresponding to a specular reflection portion in each of the spectroscopic images allows acquisition of a high-precision spectroscopic image at each of the wavelengths.

In the camera according to the aspect of the invention, it is preferable that the spectroscopic device is a wavelength tunable Fabry-Perot etalon.

In the aspect of the invention with the configuration described above, the spectroscopic device is a wavelength tunable Fabry-Perot etalon. A wavelength tunable Fabry-Perot etalon has a simple configuration in which a pair of reflection films are simply so disposed that they face each other and can readily change the wavelength of light to be separated by changing the dimension of the gap between the reflection films. Using a thus configured wavelength tunable Fabry-Perot etalon allows reduction in the size and thickness of the spectroscopic camera as compared with a case where an AOTF (acousto-optic tunable filter), an LCTF (liquid crystal tunable filter), or any other large spectroscopic device is used.

Another aspect of the invention is directed to an image processing method in a camera including a light source section that radiates light toward an object being imaged and an imaging section that captures light reflected off the object being imaged to acquire an image, the method including detecting an abnormal pixel in the image which is a pixel where the ratio of the amount of light at the pixel to a reference amount of light obtained when a reference object is irradiated with the light is greater than or equal to a predetermined value and detecting normal pixels in the image each of which is a pixel where the ratio is smaller than the predetermined value and correcting a light amount by calculating a light amount correction value for correcting the abnormal pixel based on the amounts of light at normal pixels out of the normal pixels that are located in a predetermined pixel area around the abnormal pixel in the image and replacing the amount of light at the abnormal pixel with the light amount correction value.

In the aspect of the invention, in the pixel detection step, an abnormal pixel and normal pixels in the captured image are detected, and in the light amount correction step, a light amount correction value is calculated based on the amounts of normal pixels around the abnormal pixel and the amount of light at the abnormal pixel is replaced with the light amount correction value. The amount of light at the abnormal pixel can thus be replaced with an appropriate light amount value, whereby an image having no pixel showing an abnormal amount of light corresponding to a specular reflection portion can be acquired, as in the aspect of the invention described above.

Still another aspect of the invention is directed to a camera that captures an image produced when an object being imaged is irradiated with light, and when the amount of light received at a pixel in the image is an abnormal value, the amount of light at the pixel is replaced with a light amount correction value calculated based on the amount of light received at a pixel that is located within a predetermined distance range from the pixel showing the abnormal value and shows a normal amount of received light.

In the aspect of the invention, the amount of light at a pixel showing an abnormal amount of received light is replaced with a light amount correction value based on the amount of light at a pixel located around the pixel and showing a normal amount of received light. As a result, an image having no pixel showing an abnormal value can be acquired, as in the aspect of the invention described above.

### BRIEF DESCRIPTION OF THE DRAWINGS

The invention will be described with reference to the accompanying drawings, wherein like numbers reference like elements.

FIG. 1 shows a schematic configuration of a spectroscopic analysis apparatus of a first embodiment according to the invention.

FIG. 2 is a block diagram showing the schematic configuration of the spectroscopic analysis apparatus of the first embodiment.

FIG. 3 is a plan view showing a schematic configuration of a wavelength tunable interference filter of the first embodiment.

FIG. 4 is a cross-sectional view of the wavelength tunable interference filter taken along the line IV-IV in FIG. 3.

FIG. 5 is a flowchart showing a spectroscopic image acquisition process in the spectroscopic analysis apparatus of the first embodiment.

FIG. 6 is the flowchart showing the spectroscopic image acquisition process in the spectroscopic analysis apparatus of the first embodiment.

FIG. 7 is a flowchart showing a light amount correction process in the spectroscopic analysis apparatus of the first embodiment.

FIG. 8 shows an example of a spectroscopic image acquired in the first embodiment.

FIG. 9 shows an example of a spectroscopic image having undergone light amount correction in the first embodiment.

FIG. 10 is a flowchart showing the light amount correction process in a second embodiment.

FIG. 11 is a flowchart showing the light amount correction process in a third embodiment.

### DESCRIPTION OF EXEMPLARY EMBODIMENTS

### First Embodiment

A spectroscopic analysis apparatus (camera) of a first embodiment according to the invention will be described below with reference to the drawings.

### Schematic Configuration of Spectroscopic Analysis Apparatus

FIG. 1 is a schematic view showing a schematic configuration of the spectroscopic analysis apparatus of the first embodiment. FIG. 2 is a block diagram showing the schematic configuration of the spectroscopic analysis apparatus.

A spectroscopic analysis apparatus 10 is a camera according to an embodiment of the invention and an apparatus that captures spectroscopic images of an object being imaged at a plurality of wavelengths, analyzes a spectrum in an infrared wavelength region (target wavelength region in spectroscopic image) at each pixel based on the captured spectroscopic images, and analyzes the composition of the object being imaged based on the analyzed spectra.

The spectroscopic analysis apparatus 10 of the present embodiment includes an enclosure 11, an imaging module 12, a display 13, an operation unit 14 (see FIG. 2), and a control unit 15, as shown in FIG. 1.

### Configuration of Imaging Module

The imaging module 12 includes a light incident section 121 (incident light optical system), a light source section 122, a wavelength tunable interference filter 5 (spectroscopic device), an imaging section 123, which receives incident light, and a control substrate 124.

### Configuration of Light Incident Section

The light incident section 121 is formed of a plurality of lenses, as shown in FIG. 1. The light incident section 121 has an angular field of view limited by the plurality of lenses to a predetermined angle or smaller and focuses an image of an object under inspection within the angular field of view onto the imaging section 123. Some of the plurality of lenses have inter-lens distances that can be adjusted, for example, by a user who operates the operation unit 14 to enlarge or reduce an acquired image. In the present embodiment, the lenses that form the light incident section 121 preferably form a telecentric lens unit. The telecentric lens unit can align the principal ray of incident light with the direction parallel to the optical axis, whereby the aligned light can be incident on a fixed reflection film 54 and a movable reflection film 55 of the wavelength tunable interference filter 5, which will be described later, at right angles. Further, when a telecentric lens unit is used as the lenses that form the light incident section 121, an aperture is provided in the focal position of the telecentric lens unit. The aperture has an aperture diameter controlled by the control unit 15 and can therefore control the angle of incidence of light incident on the wavelength tunable interference filter 5. The angle of incidence of the incident light, which is limited by the group of lenses, the aperture, and other components, is preferably limited to 20 degrees or smaller with respect to the optical axis, although the value varies depending on lens design and other factors.

### Configuration of Light Source Section

The light source section 122 radiates light toward an object being imaged, as shown in FIGS. 1 and 2. The light source section 122 is formed, for example, of an LED or a laser light source. Using an LED or a laser light source allows reduction both in size of the light source section 122 and in power consumption thereof.

### Configuration of Wavelength Tunable Interference Filter

FIG. 3 is a plan view showing a schematic configuration of the wavelength tunable interference filter. FIG. 4 is a cross-sectional view of the wavelength tunable interference filter taken along the line IV-IV in FIG. 3.

The wavelength tunable interference filter 5 is a Fabry-Perot etalon. The wavelength tunable interference filter 5 is, for example, a rectangular-plate-shaped optical member and includes a fixed substrate 51, which is formed to a thickness of, for example, about 500 μm, and a movable substrate 52, which is formed to a thickness of, for example, about 200 μm. Each of the fixed substrate 51 and the movable substrate 52 is made, for example, of soda glass, crystalline glass, quartz glass, lead glass, potassium glass, borosilicate glass, no-alkali glass, or any of a variety of other glass materials, or quartz. A first bonding portion 513 of the fixed substrate 51 and a second bonding portion 523 of the movable substrate are bonded to each other via a bonding film 53 (first bonding film 531 and second bonding film 532) formed, for example, of a plasma polymerization film primarily made, for example, of siloxane so that the fixed substrate 51 and the movable substrate 52 are integrated with each other.

A fixed reflection film 54 is provided on the fixed substrate 51, and a movable reflection film 55 is provided on the movable substrate 52. The fixed reflection film 54 and the movable reflection film 55 are so disposed that they face each other via a gap G1. The wavelength tunable interference filter 5 is provided with an electrostatic actuator 56, which is used to adjust (change) the dimension of the gap G1. The electrostatic actuator 56 is formed of a fixed electrode 561 provided on the fixed substrate 51 and a movable electrode 562 provided on the movable substrate 52. The fixed electrode 561 and the movable electrode 562 face each other via a gap G2. The fixed electrode 561 and the movable electrode 562 may be directly provided on substrate surfaces of the fixed substrate 51 and the movable substrate 52, respectively, or may be provided thereon via other film members. The dimension of the G2 is greater than the dimension of the gap G1.

In a filter plan view or FIG. 3 in which the wavelength tunable interference filter 5 is viewed in the substrate thickness direction of the fixed substrate 51 (movable substrate 52), a plan-view center point O of the fixed substrate 51 and the movable substrate 52 coincides with not only the center point of the fixed reflection film 54 and the center point of the movable reflection film 55 but also the center point of a movable portion 521, which will be described later.

In the following description, a plan view viewed in the substrate thickness direction of the fixed substrate 51 or the movable substrate 52, that is, a plan view in which the wavelength tunable interference filter 5 is viewed in the direction in which the fixed substrate 51, the bonding film 53, and the movable substrate 52 are layered on each other is referred to as the filter plan view.

### Configuration of Fixed Substrate

The fixed substrate 51 has an electrode placement groove 511 and a reflection film attachment portion 512 formed therein in an etching process. The fixed substrate 51 is formed to be thicker than the movable substrate 52 and is not therefore bent by an electrostatic attractive force produced when a voltage is applied between the fixed electrode 561 and the movable electrode 562 or internal stress induced in the fixed electrode 561.

Further, a cutout 514 is formed at a vertex C1 of the fixed substrate 51 and exposes a movable electrode pad 564P, which will be described later and faces the fixed substrate 51 of the wavelength tunable interference filter 5.

The electrode placement groove 511 is so formed that it has an annular shape around the plan-view center point O of the fixed substrate 51 in the filter plan view. The reflection film attachment portion 512 is so formed that it protrudes from a central portion of the electrode placement groove 511 in the plan view described above toward the movable substrate 52. A groove bottom surface of the electrode placement groove 511 forms an electrode attachment surface 511A, on which the fixed electrode 561 is disposed. Further, the front end surface of the thus protruding reflection film attachment portion 512 forms a reflection film attachment surface 512A.

Further, electrode drawing grooves 511B, which extend from the electrode placement groove 511 toward the vertices C1 and C2 at the outer circumferential edge of the fixed substrate 51, are provided in the fixed substrate 51.

The fixed electrode 561 is disposed on the electrode attachment surface 511A of the electrode placement groove 511. More specifically, the fixed electrode 561 is disposed on the electrode attachment surface 511A in an area facing the movable electrode 562 on the movable portion 521, which will be described later. An insulating film for ensuring insulation between the fixed electrode 561 and the movable electrode 562 may be layered on the fixed electrode 561.

A fixed drawn electrode 563 is provided on the fixed substrate 51 and extends from the outer circumferential edge of the fixed electrode 561 toward the vertex C2. A front end portion of the thus extending fixed drawn electrode 563 (portion located at vertex C2 of fixed substrate 51) forms a fixed electrode pad 563P, which is connected to the control substrate 124.

The present embodiment has a configuration in which the single fixed electrode 561 is provided on the electrode attachment surface 511A but may instead have, for example, a configuration in which two concentric electrodes formed around the plan-view center point O are provided on the electrode attachment surface 511A (dual electrode configuration).

The reflection film attachment portion 512 is coaxial with the electrode placement groove 511, has a substantially cylindrical shape having a diameter smaller than that of the electrode placement groove 511, and has the reflection film attachment surface 512A facing the movable substrate 52, as described above.

The fixed reflection film 54 is disposed on the reflection film attachment portion 512, as shown in FIG. 4. The fixed reflection film 54 can be formed, for example, of a metal film made, for example, of Ag or an alloy film made, for example, of an Ag alloy. The fixed reflection film 54 may instead be formed of a dielectric multilayer film, for example, having a high refractive layer made of TiO₂ and a low refractive layer made of SiO₂. The fixed reflection film 54 may still instead be a reflection film formed of a metal film (or alloy film) layered on a dielectric multilayer film, a reflection film formed of a dielectric multilayer film layered on a metal film (or alloy film), or a reflection film that is a laminate of a single-layer refractive layer (made, for example, of TiO₂ or SiO₂) and a metal film (or alloy film).

An antireflection film may be formed on a light incident surface of the fixed substrate 51 (surface on which fixed reflection film 54 is not provided) in a position corresponding to the fixed reflection film 54. The antireflection film can be formed by alternately layering a low refractive index film and a high refractive index film on each other, and the thus formed antireflection film decreases visible light reflectance of the surface of the fixed substrate 51 whereas increasing visible light transmittance thereof.

Part of the surface of the fixed substrate 51 that faces the movable substrate 52, specifically, the surface where the electrode placement groove 511, the reflection film attachment portion 512, or the electrode drawing grooves 511B are not formed in the etching process forms the first bonding portion 513. A first bonding film 531 is provided on the first bonding portion 513 and bonded to a second bonding film 532 provided on the movable substrate 52, whereby the fixed substrate 51 and the movable substrate 52 are bonded to each other as described above.

### Configuration of Movable Substrate

The movable substrate 52 has the movable portion 521, which is circular and formed around the plan-view center point O, a holding portion 522, which is coaxial with the movable portion 521 and holds the movable portion 521, and a substrate outer circumferential portion 525, which is provided in an area outside the holding portion 522, in the filter plan view or FIG. 3.

Further, the movable substrate 52 has a cutout 524 formed in correspondence with the vertex C2, and the cutout 524 exposes the fixed electrode pad 563P when the wavelength tunable interference filter 5 is viewed from the side where the movable substrate 52 is present, as shown in FIG. 3.

The movable portion 521 is formed to be thicker than the holding portion 522. In the present embodiment, for example, the movable portion 521 is formed to be as thick as the movable substrate 52. The movable portion 521 is so formed that it has a diameter greater than at least the diameter of the outer circumferential edge of the reflection film attachment surface 512A in the filter plan view. The movable electrode 562 and the movable reflection film 55 are disposed on the movable portion 521.

An antireflection film may be formed on the surface of the movable portion 521 that faces away from the fixed substrate 51, as in the case of the fixed substrate 51. The antireflection film can be formed by alternately layering a low refractive index film and a high refractive index film on each other, and the thus formed antireflection film decreases visible light reflectance of the surface of the movable substrate 52 whereas increasing visible light transmittance thereof.

The movable electrode 562 faces the fixed electrode 561 via the gap G2 and is so formed that it has an annular shape that conforms to the shape of the fixed electrode 561. A movable drawn electrode 564 is provided on the movable substrate 52 and extends from the outer circumferential edge of the movable electrode 562 toward a vertex C1 of the movable substrate 52. A front end portion of the thus extending movable drawn electrode 564 (portion located at vertex C1 of movable substrate 52) forms the movable electrode pad 564P, which is connected to the control substrate 124.

The movable reflection film 55 is so disposed on a central portion of a movable surface 521A of the movable portion 521 that the movable reflection film 55 faces the fixed reflection film 54 via the gap G1. The movable reflection film 55 has the same configuration as that of the fixed reflection film 54 described above.

In the present embodiment, the dimension of the G2 is greater than the dimension of the gap G1 as described above by way of example, but the dimensions of the gaps are not necessarily set this way. For example, when light under measurement is infrared light or far infrared light, the dimension of the gap G1 may be greater than the dimension of the gap G2 depending on the wavelength region of the light under measurement.

The holding portion 522 is a diaphragm that surrounds the movable portion 521 and is formed to be thinner than the movable portion 521. The thus configured holding portion 522 is more readily bent than the movable portion 521 and can therefore displace the movable portion 521 toward the fixed substrate 51 under a small amount of electrostatic attractive force. Since the movable portion 521 is thicker and therefore more rigid than the holding portion 522, the movable portion 521 is not deformed when the holding portion 522 is attracted toward the fixed substrate 51 under an electrostatic attractive force. The movable reflection film 55 disposed on the movable portion 521 will therefore not be bent, whereby the fixed reflection film 54 and the movable reflection film 55 can be consistently maintained parallel to each other.

In the present embodiment, the diaphragm-shaped holding portion 522 is presented by way of example, but the holding portion 522 is not necessarily formed of a diaphragm. For example, beam-shaped holding portions disposed at equal angular intervals may be provided around the plan-view center point O.

The substrate outer circumferential portion 525 is disposed in an area outside the holding portion 522 in the filter plan view, as described above. The second bonding portion 523, which faces the first bonding portion 513, is provided on the surface of the substrate outer circumferential portion 525 that faces the fixed substrate 51. The second bonding film 532 is provided on the second bonding portion 523 and bonded to the first bonding film 513, whereby the fixed substrate 51 and the movable substrate 52 are bonded to each other as described above.

### Configuration of Imaging Section

The imaging section 123 can, for example, be a CCD, a CMOS device, or any other image sensor. The imaging section 123 has a photoelectric element corresponding to each pixel and outputs a spectroscopic image (image signal) formed of pixels showing the amounts of light received with the respective photoelectric elements to the control unit 15.

### Configuration of Control Substrate

The control substrate 124 is a circuit substrate that controls the action of the imaging module 12 and is connected to the light incident section 121, the light source section 122, the wavelength tunable interference filter 5, the imaging section 123, and other components. The control substrate 124 controls the action of each of the components connected thereto based on a control signal inputted from the control unit 15. For example, when the user performs zooming operation, the control substrate 124 moves a predetermined lens in the light incident section 121 or changes the aperture diameter of the aperture. Further, when the user performs operation that triggers capture of a spectroscopic image of an object being imaged for composition analysis, the control substrate 124 turns on and off the light source section 122 based on a control signal from the control unit 15. Further, the control substrate 124 applies a predetermined voltage based on a control signal from the control unit 15 to the electrostatic actuator 56 in the wavelength tunable interference filter 5 and outputs a spectroscopic image captured by the imaging section 123 to the control unit 15.

### Configuration of Display

The display 13 is so provided that it faces a display window of the enclosure 11. The display 13 may be any display capable of displaying an image, for example, a liquid crystal panel or an organic EL panel.

The display 13 in the present embodiment also serves as a tough panel and hence functions as another operation unit 14.

### Configuration of Operation Unit

The operation unit 14 is formed, for example, of a shutter button provided on the enclosure 11 and a tough panel provided on the display 13, as described above. When the user performs input operation, the operation unit 14 outputs an operation signal according to the input operation to the control unit 15. The operation unit 14 does not necessarily have the configuration described above but may have a configuration in which a plurality of operation buttons or any other components are provided in place of the touch panel.

### Configuration of Control Unit

The control unit 15 is, for example, a combination of a CPU, a memory, and other components and controls the overall action of the spectroscopic analysis apparatus 10. The control unit 15 includes a storage section 16 and a computation section 17, as shown in FIG. 2.

The storage section 16 stores an OS for controlling the overall action of the spectroscopic analysis apparatus 10, a program for achieving a variety of functions, and a variety of data. The storage section 16 has a temporal storage area that temporarily stores acquired spectroscopic images, composition analysis results, and other types of information.

An example of the variety of data stored in the storage section 16 is V-λ data representing a drive voltage applied to the electrostatic actuator 56 in the wavelength tunable interference filter 5 versus the wavelength of light allowed to pass through the wavelength tunable interference filter 5 when the drive voltage is applied.

The storage section 16 further stores correlation data (analytical curve, for example) representing correlation between a characteristic quantity extracted from an absorption spectrum associated with each component of an object under analysis (absorbance at specific wavelength) and the content of the component.

The computation section 17 reads the program stored in the storage section 16 to perform a variety of processes, and the computation section 17 then functions as a light source controller 171, a module controller 172, a pixel detector 173 (pixel detection section), a light amount corrector 174 (light amount correction section), a composition analyzer 175, and a display controller 176.

The light source controller 171 switches drive operation of the light source section 122.

The module controller 172 refers to the V-λ data and controls the electrostatic actuator 56 to change the wavelength of light allowed to pass through the wavelength tunable interference filter 5 based on the read data. The module controller 172 further controls the imaging section 123 to cause it to capture spectroscopic images.

The pixel detector 173 detects an abnormal pixel and a normal pixel that is not an abnormal pixel based on the amount of light at each pixel in each acquired spectroscopic image. An abnormal pixel corresponds to a portion where the light from the light source section 122 is specularly reflected off the surface of the object being imaged.

The light amount corrector 174 corrects the amount of light at an abnormal pixel in each spectroscopic image.

The composition analyzer 175 calculates an optical spectrum at each pixel based on the spectroscopic images in each of which the amount of light at an abnormal pixel has been corrected. The composition analyzer 175 further analyzes the composition of the object being imaged based on the calculated optical spectrum at each pixel and the correlation data stored in the storage section 16.

The display controller 176 operates when the module controller 172 controls the imaging module 12 to acquire a captured image and displays the acquired captured image on the display 13. The display controller 176 further displays the composition analysis result provided by the composition analyzer 175 on the display 13.

Specific processes carried out by the computation section 17 will be described later.

### Action of Spectroscopic Analysis Apparatus

The action of the spectroscopic analysis apparatus 10 described above will next be described below with reference to the drawings.

To perform composition analysis by using the spectroscopic analysis apparatus 10 of the present embodiment, an initial process of acquiring a reference amount of received light for absorbance calculation is first carried out. The initial process is, for example, carried out by capturing an image of a reference calibration plate (reference object) having a perfect diffuse reflection surface made, for example, of MgO₂ and measuring the amount of received light (reference amount of light) I₀ at each wavelength. Specifically, the computation section 17 uses the module controller 172 to successively change the voltage applied to the electrostatic actuator 56 to change the wavelength of the transmitted light, for example, at 10-nm intervals over a predetermined near-infrared wavelength region (700 to 1500 nm, for example). The amount of received light at each of the wavelengths is detected by the imaging section 123 and stored in the storage section 16.

In this process, the computation section 17 may use the amount of received light only at one point on the reference calibration plate as the reference amount of light or may specify a pixel range in each of the spectroscopic images of the reference calibration plate, average the amounts of received light at a predetermined number of pixels or all the pixels in the specified pixel range, and use the average as the reference amount of light.

A description will next be made of a spectroscopic image acquisition process (image processing method) in the entire spectroscopic analysis process using the spectroscopic analysis apparatus 10. In the spectroscopic analysis apparatus 10 of the present embodiment, spectroscopic images to be analyzed are acquired, for example, at 10-nm wavelength intervals over the infrared region, and the composition analyzer 175 analyzes the optical spectrum at each pixel in the spectroscopic images to be analyzed and analyzes an absorption spectrum corresponding to a component based on the analyzed optical spectrum to determine the content and other factors of the component contained in the object being imaged. A description will be made of a process of acquiring a spectroscopic image to be analyzed (spectroscopic image processing method) that is carried out before the composition analysis.

FIGS. 5 to 6 are flowcharts of the spectroscopic image acquisition process carried out by the spectroscopic analysis apparatus 10. FIG. 7 is a flowchart of the light amount correction process.

In the spectroscopic image acquisition process, the light source controller 171 first controls the light source section 122 to cause it to radiate light toward an object being imaged (step S1), as shown in FIG. 5. The module controller 172 refers to the V-λ data stored in the storage section 16, reads a drive voltage corresponding to a target wavelength, and outputs a control signal to the control substrate 124 to cause it to apply the drive voltage to the electrostatic actuator 56 (step S2). The dimension of the gap between the reflection films 54 and 55 of the wavelength tunable interference filter 5 is thus changed, and the wavelength tunable interference filter 5 is ready to transmit light of the target wavelength.

In steps S1 and S2, light reflected off the object being imaged is incident through the light incident section 121 to the wavelength tunable interference filter 5, which transmits light of a predetermined wavelength according to the dimension of the gap G1 between the reflection films 54 and 55 toward the imaging section 123. The imaging section 123 receives the transmitted light to capture a spectroscopic image P_{λk} (step S3). The captured spectroscopic image P_{λk} is outputted to the control unit 15 and stored in the storage section 16.

In the following description, the captured spectroscopic image P_{λk} has an image size x_{—max}×y_{—max}, and a pixel (x, y) of the spectroscopic image P_{λk} shows an amount of light d(x, y).

FIG. 8 shows an example of the acquired spectroscopic image.

Part of the light from the light source section 122 is specularly reflected off part of the surface of the object being imaged and incident on the light incident section 121. The spectroscopic image therefore has a pixel that shows an amount of light (brightness) greater than the reference amount of light I₀, as shown in FIG. 8.

The module controller 172 then determines whether or not any spectroscopic image that has not been acquired is left (step S4). When it is determined in step S4 that a spectroscopic image that has not been acquired is left, the control returns to step S2 and the spectroscopic image acquisition process is continued. The target wavelength at which a spectroscopic image is acquired (wavelength corresponding to drive voltage set in step S2) may be set, for example, in accordance with a component to be analyzed by the spectroscopic analysis apparatus 10 or may be set by an operator who performs the measurement as appropriate. For example, to detect the amounts and calories of lipid, glucide, protein, and water contained in a food product by using the spectroscopic analysis apparatus, a wavelength at which the characteristic quantity of each of at least the lipid, glucide, protein, and water is obtained may be set as the target wavelength, and it may be determined in step S4 whether or not a spectroscopic image of each of the target wavelengths has been acquired.

Spectroscopic images may instead be successively acquired at predetermined wavelength intervals (10-nm intervals, for example).

Spectroscopic images P_{λk} corresponding to target wavelengths λk (k=1, 2, 3, . . . Kmax) are thus acquired.

When it is determined in step S4 that the spectroscopic images P_{λk} of all the target wavelengths have been acquired, a process of correcting an abnormal pixel in the spectroscopic images is carried out.

In this process, the pixel detector 173 first initializes a setting variable k for selecting a spectroscopic image (k=1) (step S5).

The pixel detector 173 then selects a spectroscopic image P_{λk} (step S6) and initializes setting variables i and j for setting a pixel position on the object under detection (i=1, j=1) (step S7).

The pixel detector 173 then calculates the ratio of the amount of light d(i, j) at a pixel (i, j) in the spectroscopic image P_{λk} to the reference amount of light I₀ (reflectance ratio) and determines whether or not the reflection ratio is smaller than or equal to 1 (step S8). That is, it is determined whether or not the amount of light d(i, j) is smaller than or equal to the reference amount of light I₀. To calculate the reflectance ratio for a first spectroscopic image of a wavelength A, the reference amount of light I₀ at the wavelength A is used.

When d(i, j)/Iₒ≦1 in step S8, it is determined that the pixel (i, j) is a “normal pixel,” which is not a pixel that corresponds to a specular reflection portion, and “1” is inputted to flag data f(i, j) for the pixel (i, j) (step S9).

On the other hand, when d(i, j)/Iₒ>1 in step S8, it is determined that the pixel (i, j) is an “abnormal pixel,” which is a pixel that corresponds to a specular reflection portion, and “0” is inputted to the flag data f(i, j) for the pixel (i, j) (step S10).

After step S9 or S10, the pixel detector 173 adds “1” to the setting variable i (step S11: i=i+1) and determines whether or not the x coordinate specified by the setting variable i in the image falls within the image size (i≦x_{—max}) (step S12).

When the determination result in step S12 is “Yes”, the control returns to step S8.

On the other hand, when the determination result in step S12 is “No,” the pixel detector 173 initializes the setting variable i (i=1) and adds “1” to the setting variable j (step S13: j=j+1) and determines whether or not the y coordinate specified by the setting variable j in the image falls within the image size (j≦y_{—max}) (step S14).

When the determination result in step S14 is “Yes,” the control returns to step S8.

On the other hand, when the determination result in step S14 is “No,” the light amount corrector 174 initializes the setting variables i and j (i=1, j=1) (step S15) as in step S7, as shown in FIG. 6. The light amount corrector 174 then determines whether or not the flag data f(i, j) for the pixel (i, j) is “1” (step S16). That is, the light amount corrector 174 determines whether or not the pixel (i, j) is a normal pixel.

When the determination result in step S16 is “No,” that is, when the pixel (i, j) is an abnormal pixel, a light amount correction process (step S100) is carried out.

In the light amount correction process in step S100, the process shown in FIG. 7 is carried out.

The light amount corrector 174 first acquires a pixel area (i_min≦i≦i_max, j_min≦j≦j_max) formed of pixels around the abnormal pixel (i, j) as (step S101).

Specifically, in step S101, the following range around the pixel (i, j) is set as the pixel area: x=i−m1 to i+m2; and y=j−n1 to j+n2. That is, i_min=i−m1, i_max=i+m2, j_min=j−n1, and j_max=j+n2. When i−m1<1, i_min is set at 1, and when j−n1<1, j_min is set at 1. Further, when i+m2>x_max, i_max is set at x_max, and when j+n2>y_max, j_max is set at y_max.

The values of m1, m2, n1, and n2 may be preset values or may be values set by the user. When the values of m1, m2, n1, and n2 can be set by the user, a value for the light amount correction has changeable correction precision.

The light amount corrector 174 then initializes a normal light amount sum. “D_sum” and the number of normal pixels “c” (D_sum=0, c=0) (step S102) and sets the setting variables i and j at the initial values (i=i_min, j=j_min) (step S103).

The light amount corrector 174 then substitutes D_sum+d(i, j)×f(i, j) for the normal light amount sum D_sum and substitutes c+f(i, j) for the number of normal pixels c (step S104). When the pixel (i, j) is an abnormal pixel, f(i, j) is “0” and no addition is therefore made. Only when the pixel (i, j) is a normal pixel, the amount of light at the pixel (i, j) is added to the normal light amount sum D_sum, and the number of normal pixels c is incremented by 1.

The light amount corrector 174 then adds “1” to the setting variable i (step S105: i=i+1) and determines whether or not the x coordinate specified by the setting variable i in the image falls within the pixel area (i≦i_max) (step S106).

When the determination result in step S106 is “Yes,” the control returns to step S104.

On the other hand, when the determination result in step S106 is “No,” the light amount corrector 174 sets the setting variable i back to the initial value (i=i_min), adds “1” to the setting variable j (step S107: j=j+1), and determines whether or not the y coordinate specified by the setting variable j in the image falls within the pixel area (j≦j_max) (step S108).

When the determination result in step S108 is “Yes,” the control returns to step S104.

On the other hand, the determination result in step S108 is “No,” the amount of light d(i, j) at the abnormal pixel (i, j) is replaced with D_sum/c (step S109). That is, the amount of light at the abnormal pixel (i, j) is replaced with the average of the amounts of light at the normal pixels in the pixel area having been set.

FIG. 9 shows an example of a spectroscopic image having undergone the light amount correction. The light amount correction process in step S100 described above replaces an abnormal pixel (i, j) corresponding to a specular reflection portion, such as the portion shown in FIG. 8, with a pixel showing a normal light amount value, such as that shown in FIG. 9.

Referring back to FIG. 6, after step S100 described above is executed or when the determination result in step S16 is “Yes,” the light amount corrector 174 adds “1” to the setting variable i (step S17: i=i+1) and determines whether or not the x coordinate specified by the setting variable i in the image falls within the image size (i≦x_max) (step S18).

When the determination result in step S18 is “Yes,” the control returns to step S16.

On the other hand, when the determination result in step S18 is “No,” the light amount corrector 174 sets the setting variable i back to the initial value (i=1), adds “1” to the setting variable j (step S19: j=j+1), and determines whether or not the y coordinate specified by the setting variable j in the image falls within the image size (j≦y_max) (step S20).

When the determination result in step S20 is “Yes,” the control returns to step S16.

When the determination result in step S20 is “No,” the spectroscopic image P_{λk} in which the amount of light at each abnormal pixel is replaced with a light amount correction value is acquired and stored in the storage section 16.

Thereafter, “1” is added to the setting variable k, which is used to select a spectroscopic image, (step S21: k=k+1), and it is determined whether or not k≦Kmax (step S22). When the determination result in step S22 is “Yes,” the control returns to step S6. On the other hand, when the determination result in step S22 is “No,” which means that an spectroscopic image in which the amount of light at each abnormal pixel has been corrected has been acquired for each of the target wavelengths λk (k=1, 2, 3 . . . Kmax), the spectroscopic image acquisition process is terminated.

### Advantageous Effects of First Embodiment

In the spectroscopic analysis apparatus 10 of the present embodiment, the light source section 122 radiates light toward an object being imaged, the wavelength tunable interference filter 5 receives light reflected off the object being imaged and transmits light of a wavelength according to the dimension of the gap G1 between the reflection films 54 and 55, and the imaging section 123 captures the transmitted light to acquire a spectroscopic image. The pixel detector 173 calculates the reflectance ratio of the amount of light at each pixel in the captured spectroscopic image to the reference amount of light and detects an abnormal pixel showing a reflectance ratio greater than 1 and a normal pixel showing a reflectance ratio smaller than or equal to 1. The light amount corrector 174 then sets a pixel area having a predetermined range including an abnormal pixel, calculates a light amount correction value based on the amounts of light of normal pixels within the pixel area, and replaces the amount of light at the abnormal pixel with the light amount correction value.

Therefore, even when the light from the light source section 122 is specularly reflected off the surface of the object being imaged and hence the resultant spectroscopic image shows abnormal brightness, the amount of light at the abnormal pixel can be replaced with an appropriate light amount value based on the amounts of light at the normal pixels, whereby a spectroscopic image in which no abnormal pixel is present can be acquired.

Therefore, when spectroscopic measurement is made based on the acquired spectroscopic image, an optical spectrum at each pixel in spectroscopic images at a plurality of wavelengths can be precisely calculated because no abnormal pixel showing a light amount value higher than the reference amount of light is present in the spectroscopic images, whereby the composition of the object being imaged can be precisely analyzed.

In the present embodiment, the light amount corrector 174 calculates a light amount correction value in the form of the average of the amounts of light at normal pixels within the pixel area. Therefore, even when the amount of light at an abnormal pixel is unknown, the amount of light at the abnormal pixel is replaced with the average of the amounts of light at pixels around the abnormal pixels so that the amount of light at the abnormal pixel can be replaced with a value close to an actual amount of light, whereby a high-precision spectroscopic image can be acquired. Further, since the amount of light at each normal pixel is acquired, the average of the amounts of light at the normal pixels can be readily acquired, whereby the correction process can be quickly carried out.

The light amount corrector 174, when it sets a pixel area, can specify the range of the pixel area based on user's input. Therefore, for example, when a large number of abnormal pixels present in the pixel area prevent calculation of a precise light amount correction value, the range of the pixel area can be widened. On the other hand, narrowing the range of the pixel area suppresses variation in the light amount values at normal pixels, whereby more precise light amount correction value can be calculated. Further, the size of the pixel area along the X direction (m1, m2) and the size of the pixel area along the Y direction (n1, n2) can be set with respect to an abnormal pixel (i, j). Therefore, for example, in a case where an abnormal pixel is located in the vicinity of an edge portion where the brightness greatly changes, the pixel area can be so set that it does not include the edge portion.

### Second Embodiment

A second embodiment according to the invention will next be described with reference to the drawings.

In the first embodiment described above, the amount of light at an abnormal pixel (i, j) in a spectroscopic image P_{λk} is replaced, by way of example, with a light amount correction value in the form of the average of the amounts of light at normal pixels in a predetermined pixel area including the abnormal pixel. The second embodiment differs from the first embodiment described above in that the light amount correction value is calculated in the form of the median of the amounts of light at normal pixels.

FIG. 10 is a flowchart showing the light amount correction process in the second embodiment.

In the following description, the same configurations as those in the first embodiment and the items having already been described in the first embodiment have the same reference characters and will not be described or described in a simplified manner.

In the present embodiment, in the light amount correction process in step S100, the process in step S101 is carried out to set a predetermined pixel area including an abnormal pixel (i, j) detected in a spectroscopic image P_{λk} as shown in FIG. 10, as in the first embodiment.

Thereafter, the number of normal pixels “c” is initialized or c=0 is inputted (step S111). Further, step S103 is carried out to set the setting variables i and j at the initial values (i=i_min, j=j_min).

The light amount corrector 174 then inputs the amount of light d(i, j) at a normal pixel to a normal value sequence d_n(c) (step S112). That is, d(i, j)×f(i, j) is inputted to d_n(c).

Thereafter, f(i, j) is added to the number of normal pixels “c” or addition of c+f(i, j) is made (step S113). Therefore, when the pixel (i, j) is a normal pixel, “1” is added to the number of normal pixels c. The processes in steps S105 to S108 are then carried out. In the present embodiment, when the determination result in step S106 is “Yes,” the control returns to step S112, and so does in step S108.

As a result, values are sequentially inputted to the normal value sequence as follows: d_n(0)=d(i_min, j_min), d_n(1)=d(i_min+1, j_min) . . . d_n(c)=d(i, j).

When the determination result in step S108 is “No,” the light amount corrector 174 sorts the acquired normal value sequence d_n(0) to d_n(c−1) in ascending or descending order to acquire a sorted sequence S_n(1) to S_n(c), which are produced by, (step S114). For example, when c=5, d_n(0), d_n(1), d_n(2), d_n(3), and d_n(4) are acquired, which are sorted in ascending order to acquire S_n(1), S_n(2), S_n(3), S_n(4), and S_n(5).

The light amount corrector 174 then determines whether or not the number of normal pixels c is an odd number (step S115). When c is an odd number, the light amount corrector 174 replaces the amount of light d(i, j) at the abnormal pixel (i, j) with S_n{(c+1)/2} (step S116).

When the determination result in step S115 is “No” (when it is determined that c is an even number), the light amount corrector replaces the amount of light d(i, j) at the abnormal pixel (i, j) with [S_n{(c/2)+1}+S_n(c/2)]/2 (step S117).

That is, in the present embodiment, the amount of light at the abnormal pixel (i, j) is replaced with the median of the amounts of light at normal pixels in a pixel area having been set.

### Advantageous Effect of Second Embodiment

In the present embodiment, the light amount corrector 174 calculates a light amount correction value in the form of the median of the amounts of light at normal pixels in a pixel area and replaces the amount of light at an abnormal pixel (i, j) with the light amount correction value.

As a result, even when the amounts of light at normal pixels vary from each other in the pixel area, selecting a light amount correction value based on the median in a probability distribution allows accurate light amount correction and hence acquisition of a high-precision spectroscopic image.

### Third Embodiment

A third embodiment according to the invention will next be described with reference to the drawings.

In the first and second embodiments described above, the average or median of the amounts of light at normal pixels is selected as the light amount correction value in step S100. The present embodiment differs from the first and second embodiments described above in that the average of the amounts of light at normal pixels in the quartile range is acquired.

FIG. 11 is a flowchart showing the light amount correction process in the third embodiment.

In the present embodiment, the light amount corrector 174 carries out the processes in steps S101 to S114 as in the second embodiment to sort the light amount sequence d_n(0) to d_n(c−1), which represent the amounts of light at normal pixels in a pixel area, to acquire a sorted sequence S_n(1) to S_n(c), as shown in FIG. 11.

Thereafter, in the present embodiment, the light amount corrector 174 calculates the light amount correction value in the form of the average of the amounts of light at the normal pixels in the quartile range as indicated by the following expression and replaces the amount of light d(i, j) at the abnormal pixel (i, j) with the light amount correction value (step S121).

$$d ( i , j ) = \frac{{\sum }_{k = c / 4}^{3 c / 4} S\_n ( k )}{c / 2} \qquad ( 1 )$$

### Advantageous Effect of Third Embodiment

In the present embodiment, the light amount corrector 174 calculates a light amount correction value in the form of the average of the amounts of light at normal pixels in the quartile range in a pixel area and replaces the amount of light at an abnormal pixel (i, j) with the light amount correction value.

Since each of the amounts of light at normal pixels in the quartile range is a value other than those greater or smaller than the other values, the amount of light at an abnormal pixel can be corrected by using a more accurate amount of light, whereby a high-precision spectroscopic image can be acquired.

### Other Embodiments

The invention is not limited to the embodiments described above, and variations, modifications, and other improvements to the extent that the advantage of the invention is achieved fall within the scope of the invention.

For example, in the embodiments described above, the spectroscopic analysis apparatus 10 is presented by way of example. The invention is also applicable to a typical spectroscopic camera that is not intended for composition analysis or other types of analysis of an object being imaged.

In the first to third embodiments described above, the spectroscopic analysis apparatus 10 including a spectroscopic camera that acquires a spectroscopic image is presented by way of example, but the spectroscopic analysis apparatus 10 does not necessarily include a spectroscopic camera. For example, the invention is also applicable to a typical camera that captures, for example, a color image. In this case as well, based on the amount of light at each pixel in a captured image (for example, each of R, G, and B monochromatic images that form a color image captured by using RGB color filters) and a reference amount of light, the reflection ratio at the pixel is calculated, the pixel is detected as an abnormal pixel when the reflection ratio is greater than a predetermined value whereas detected as a normal pixel when the reflection ratio is smaller than or equal to the predetermined value, and the amount of light at the abnormal pixel is corrected based on the amount of light at the normal pixel.

Further, the above first to third embodiments have been described with reference to the cases where the amount of light at an abnormal pixel is corrected by using the average of the amounts of light at normal pixels, by using the median of the amounts of light at normal pixels, and by using the average of the amounts of light at normal pixels in the quartile range, respectively, but the amount of light at an abnormal pixel is not necessarily corrected as described above.

For example, the light amount correction value may be calculated based on the amounts of light at pixels around an abnormal pixel by using spline interpolation, and the amount of light at the abnormal pixel may be replaced with the calculated light amount correction value. In this case, the amount of light at a pixel in a corrected image smoothly changes to the amount of light at an adjacent pixel, whereby an inconvenient situation in which the amount of light at an abnormal pixel is replaced with an unnatural amount of light is avoided.

The above first to third embodiments have been described with reference to the case where it is determined whether or not the reflection ratio (d(i, j)/I₀) is smaller than or equal to a predetermined value (1) set in advance, but the reflection ratio is not necessarily used. For example, an input section that receives a predetermined value inputted by the user who operates the operation unit 14 and uses the inputted predetermined value to determine whether a pixel in question is a normal pixel or an abnormal pixel may be provided.

In this case, in a situation in which correct light amount correction cannot be made, for example, when the reflection ratios at the pixels in an acquired image are high as a whole, abnormal pixel detection sensitivity can be lowered by changing the predetermined value described above, which serves as a threshold, as appropriate, whereby an image in which the proportion of specular reflection portion is reduced can be acquired.

Further, the input section does not necessarily acquire a value based on user's operation. For example, when the number of abnormal pixels in an acquired image is greater than a predetermined upper limit, a process of lowering the predetermined value described above, which is used to determine whether a pixel in question is a normal or abnormal pixel, may be carried out. In this case as well, the same advantageous effect as that described above can be provided.

In the first to third embodiments described above, the light amount corrector 174, when it sets a pixel area around an abnormal pixel (i, j), may carry out a process of notifying a user of an abnormal situation with an alert (notification displayed on the display, audio notification, or other forms of notification) when the number of abnormal pixels contained in the pixel area is greater than or equal to a predetermined first threshold or when the proportion of the number of normal pixels to the number of abnormal pixels is smaller than a second threshold. Instead of the notification, a spectroscopic image may be reacquired by performing the measurement (image capturing) again.

Further, the light amount corrector 174 may carry out, when it sets a pixel area, a process of widening the set range of the pixel area when the number of abnormal pixels contained in the pixel area is greater than or equal to the predetermined first threshold or when the proportion of the number of normal pixels to the number of abnormal pixels is smaller than the second threshold. That is, in step S101, each of the values of m1, m2, n1, and n2 may be increased by a predetermined amount, and a pixel area may be set again in accordance with the increased values. In this case, the number of normal pixels is likely to be greater than the number of abnormal pixels, whereby a light amount correction value can be calculated based on the larger number of normal pixels.

Further, the light amount corrector 174 may carry out, when it sets a pixel area, a process of narrowing the set range of the pixel area when the number of abnormal pixels contained in the pixel area is smaller than or equal to a predetermined third threshold or when the proportion of the number of normal pixels to the number of abnormal pixels is greater than a predetermined fourth threshold. That is, in step S101, each of the values of m1, m2, n1, and n2 may be reduced by a predetermined amount, and the pixel area may be set in accordance with the reduced values for calculation of a light amount correction value based on normal pixels closer to the abnormal pixel (i, j). In this case, a more accurate light amount correction value can be calculated based on normal pixels close to the abnormal pixel (i, j).

Further, the light amount corrector 174 may determine whether or not an edge portion where the amount of light greatly changes from a pixel to an adjacent pixel is present in the pixel area. When determining that such an edge portion is present, the light amount corrector 174 may further detect the positional relationship between an abnormal pixel (i, j) and the pixels in the edge portion and set a pixel area that does not include the edge portion. In this case, the edge portion or any other area where the amount of light greatly changes can be excluded, whereby an accurate light amount correction value can be calculated.

In each of the embodiments described above, the wavelength tunable interference filter 5 may be accommodated in a package, and the packaged wavelength tunable interference filter 5 may be incorporated in the spectroscopic analysis apparatus 10. In this case, the package can be exhausted to a vacuum and sealed to improve the response of the electrostatic actuator 56 in the wavelength tunable interference filter 5 when the electrostatic actuator 56 is driven by voltage application.

In each of the embodiments described above, after the reference calibration plate having a perfect diffuse reflection surface is irradiated with light, the amount of light received from the reference calibration plate is used as the reference amount of light I₀, and the pixel detector 173 calculates the reflectance ratio based on the reference amount of light I₀. Instead, for example, a reference calibration plate that absorbs part of light incident on the surface thereof and hence does not provide perfect diffuse reflection may be used. In this case, the pixel detector 173 can determine whether or not a pixel in question is an abnormal pixel by determining whether or not the reflectance ratio is smaller than or equal to a predetermined value smaller than to 1.

The wavelength tunable interference filter 5 is configured to include the electrostatic actuator 56, which changes the dimension of the gap between the reflection films 54 and 55 based on voltage application, but the dimension of the gap is not necessarily changed this way.

For example, an induction actuator having a first induction coil provided in place of the fixed electrode 561 and a second induction coil or a permanent magnet provided in place of the movable electrode 562 may be used.

Further, a piezoelectric actuator may be used in place of the electrostatic actuator 56. In this case, for example, a lower electrode layer, a piezoelectric film, and an upper electrode layer are layered on each other and disposed at the holding portion 522, and a voltage applied between the lower electrode layer and the upper electrode layer can be changed as an input value to expand or contract the piezoelectric film so as to bend the holding portion 522.

Further, each of the embodiments described above shows the case where the wavelength tunable interference filter 5 is configured as a Fabry-Perot etalon and includes the fixed substrate 51 and the movable substrate 52 so bonded to each other that they face each other with the fixed reflection film 54 provided on the fixed substrate 51 and the movable reflection film 55 provided on the movable substrate 52, but the configuration of the wavelength tunable interference filter 5 is not limited thereto.

For example, the wavelength tunable interference filter 5 may be so configured that the fixed substrate 51 and the movable substrate 52 are not bonded to each other but a gap changer that changes the gap between the reflection films, such as a piezoelectric device, is provided between the substrates.

Further, the wavelength tunable interference filter 5 is not necessarily formed of two substrates. For example, a wavelength tunable interference filter so configured that two reflection films are layered on a single substrate with a sacrifice layer between the reflection films and the sacrifice layer is etched away or otherwise removed to form a gap may be used.

Moreover, as the spectroscopic device, an AOTF (acousto-optic tunable filter), an LCTF (liquid crystal tunable filter), or any other similar device may be used. In this case, however, size reduction of the spectroscopic camera (spectroscopic analysis apparatus 10) is likely to be difficult. It is therefore preferable to use a Fabry-Perot etalon.

Further, in each of the embodiments described above, the wavelength tunable interference filter 5 that can change the wavelength of transmitted light by changing the gap G1 between the reflection films 54 and 55 is presented by way of example, but the wavelength tunable interference filter 5 is not necessarily used. For example, a wavelength-fixed interference filter (Fabry-Perot etalon) may be used. In this case, the amount of light at an abnormal pixel can be appropriately corrected in a spectroscopic image of a specific wavelength according to the dimension of the gap between the reflection films of the interference filter.

In addition, the specific structure according to any of the embodiments of the invention can be changed as appropriate in actual implementation of the invention to any other structure to the extent that the advantage of the invention is achieved.

The entire disclosure of Japanese Patent Application No. 2013-050096, filed Mar. 13, 2013 is expressly incorporated by reference herein.

What is claimed is:

1. A camera comprising:
a light source section that radiates light toward an object being imaged;
an imaging section that captures light reflected off the object being imaged to acquire an image;
a pixel detection section that detects an abnormal pixel in the image which is a pixel where the ratio of the amount of light at the pixel to a reference amount of light obtained when a reference object is irradiated with the light is greater than or equal to a predetermined value and detects normal pixels in the image each of which is a pixel where the ratio is smaller than the predetermined value; and
a light amount correction section that calculates a light amount correction value based on the amounts of light at normal pixels out of the normal pixels that are separated from the abnormal pixel in the image but located within a predetermined distance range and replaces the amount of light at the abnormal pixel with the light amount correction value.

2. The camera according to claim 1, further comprising:
a spectroscopic device that selects and separates light of a predetermined wavelength from the light reflected off the object being imaged,
wherein the imaging section captures the light of the wavelength selected by the spectroscopic device to acquire the image.

3. The camera according to claim 1,
wherein the light amount correction section calculates the light amount correction value in the form of the average of the amounts of light at the normal pixels located within the predetermined distance range.

4. The camera according to claim 1,
wherein the light amount correction section calculates the light amount correction value in the form of the median of the amounts of light at the normal pixels located within the predetermined distance range.

5. The camera according to claim 1,
wherein the light amount correction section calculates the light amount correction value in the form of the average of the amounts of light in the quartile range at the normal pixels located within the predetermined distance range.

6. The camera according to claim 1, further comprising an input section that sets the predetermined value based on which each pixel in the image is determined to be an abnormal pixel or a normal pixel.

7. The camera according to claim 1, further comprising an input section that sets the predetermined distance range that defines a range within which the normal pixels used to correct the amount of light at the abnormal pixel are located.

8. The camera according to claim 2,
wherein the spectroscopic device is capable of changing the wavelength to be selected.

9. The camera according to claim 2,
wherein the spectroscopic device is a wavelength tunable Fabry-Perot etalon.

10. An image processing method in a camera including a light source section that radiates light toward an object being imaged and an imaging section that captures light reflected off the object being imaged to acquire an image, the method comprising:
detecting an abnormal pixel in the image which is a pixel where the ratio of the amount of light at the pixel to a reference amount of light obtained when a reference object is irradiated with the light is greater than or equal to a predetermined value and detecting normal pixels in the image each of which is a pixel where the ratio is smaller than the predetermined value; and
correcting a light amount by calculating a light amount correction value for correcting the abnormal pixel based on the amounts of light at normal pixels out of the normal pixels that are located in a predetermined pixel area around the abnormal pixel in the image and replacing the amount of light at the abnormal pixel with the light amount correction value.

11. A camera that captures an image produced when an object being imaged is irradiated with light,
wherein when the amount of light received at a pixel in the image is an abnormal value, the amount of light at the pixel is replaced with a light amount correction value calculated based on the amount of light received at a pixel that is located within a predetermined distance range from the pixel showing the abnormal value and shows a normal amount of received light.
